(19) United States
(12) Patent Application Publication
(10) Pub. No.: US 2025/0263270 A1
(43) Pub. Date: Aug. 21, 2025

(54) MULTI-LEVEL CONVEYOR SYSTEM WITH DUAL LOADING-UNLOADING STATIONS

(71) Applicant: A. J. ANTUNES & CO., CAROL STREAM, IL (US)

(72) Inventors: JOE CARONE, DARIEN, IL (US); ROBERT C. JONELIS, CRYSTAL LAKE, IL (US); STEVEN BAST, LOMBARD, IL (US); CHAD ELLIOTT, NAPERVILLE, IL (US); ERIC LINDH, LAKE VILLA, IL (US); BRIAN SCHWARTZ, LAKE ZURICH, IL (US)

(21) Appl. No.: 19/057,273

(22) Filed: Feb. 19, 2025

Related U.S. Application Data
(60) Provisional application No. 63/556,169, filed on Feb. 21, 2024.

(51) Int. Cl. B66B 11/00; B66B 9/00

(52) U.S. Cl. CPC B66B 11/006; B66B 9/00

(57) ABSTRACT

A smart conveyor system for an establishment comprises a vertically oriented conveyor tower, having a vertically moving conveyor disposed therein, a first horizontally oriented loading/unloading station having first conveyors operatively associated with the vertically oriented conveyor tower for delivering first objects to the vertically oriented conveyor tower, and for receiving second objects from the vertically oriented conveyor tower, and a second horizontally oriented loading/unloading station having second conveyors operatively associated with the vertically oriented conveyor tower for delivering the first objects from the vertically oriented conveyor tower, and for delivering second objects to the vertically oriented conveyor tower.

### FIELD OF THE INVENTION

The present invention relates generally to restaurant food service equipment, and more particularly to a multi-level conveyor system which has dual loading/unloading stations, and a vertical conveyor system therebetween, such that the conveyor system can service multiple levels of an establishment.

### BACKGROUND OF THE INVENTION

Dumbwaiters are of course well known and have been in use for a long time so as to serve to transport food, goods, packages, and the like, between different building levels or floors when it would otherwise be too strenuous, tiresome, and dangerous for people to engage in the transportation of such products. More particularly, within a multi-level or multi-story restaurant establishment where, for example, the kitchen is located upon one floor or level and the dining areas are located upon another floor or level, it is clearly impractical and unsafe for restaurant personnel to carry food trays, with patron food orders disposed thereon, or heavy bus tubs, with dirty dishes disposed thereon, between floors or levels, especially during an entire work shift. In addition, the food orders to be delivered by conventional dumbwaiters must be unloaded first before being loaded with dirty dishes in bus tubs for the return trip. This system is very time-consuming and inefficient. Furthermore, conventional dumbwaiters are not partitioned so as to effectively maintain the conveyor areas, for transporting prepared food orders and dirty dishes, separate from each other for sanitary purposes and for compliance with regulatory codes governing sanitary conditions within restaurant establishments. Still further, conventional dumbwaiters need to have dedicated personnel load and unload each food order tray or each dirty dish bus tub which renders the overall system even more time-consuming and inefficient. Some examples of such conventional dumbwaiters may be found within United States Published Patent Application 2015/01836129 which published on Jul. 2, 2015 for Oh et al., and U.S. Pat. No. 3,782,563 which issued on Jan. 1, 1974 to Brockmeyer et al.

A need therefore exists in the art for a new and improved multi-level conveyor system. Another need exists in the art for a new and improved multi-level conveyor system which can be utilized within restaurant facilities. Still another need exists in the art for a new and improved multi-level conveyor system which can be utilized within restaurant establishments wherein, for example, the kitchen is located upon one floor or level and the dining areas are located upon a different floor or level. Yet another need exists in the art for a new and improved multi-level conveyor system which can be utilized within restaurant establishments wherein, for example, the kitchen facility is located upon one floor or level and the dining areas are located upon a different floor or level, and wherein patron food orders and bus tubs containing dirty dishes can be simultaneously conveyed between the kitchen facility and the dining areas. Still yet another need exists in the art for a new and improved multi-level conveyor system which can be utilized within restaurant establishments wherein, for example, the kitchen facility is located upon one floor or level and the dining areas are located upon a different floor or level, and wherein patron food orders and bus tubs containing dirty dishes can be simultaneously conveyed between the kitchen facility and the dining areas so as to improve the efficiency of the system in servicing the restaurant patrons. Yet still another need exists in the art for a new and improved multi-level conveyor system which can be utilized within restaurant establishments wherein, for example, the kitchen facility is located upon one floor or level and the dining areas are located upon a different floor or level, wherein patron food orders and bus tubs containing dirty dishes can be simultaneously conveyed between the kitchen facility and the dining areas so as to improve the efficiency of the system in servicing the restaurant patrons, and wherein the loading and unloading of patron food orders and dirty dishes is heavily automated so as to improve the efficiency of the system still further.

A further need exists in the art for a new and improved multi-level conveyor system which can be utilized within restaurant establishments wherein, for example, the kitchen facility is located upon one floor or level and the dining areas are located upon a different floor or level, wherein patron food orders and bus tubs containing dirty dishes can be simultaneously conveyed between the kitchen facility and the dining areas so as to improve the efficiency of the system in servicing the restaurant patrons, wherein the loading and unloading of patron food orders and dirty dishes is heavily automated so as to improve the efficiency of the system still further, and wherein patron food orders are maintained separate from bus tubs containing dirty dishes so as to maximize sanitary conditions within the restaurant facility. A still further need exists in the art for a new and improved multi-level conveyor system which can be utilized within restaurant establishments wherein, for example, the kitchen facility is located upon one floor or level and the dining areas are located upon a different floor or level, wherein patron food orders and bus tubs containing dirty dishes can be simultaneously conveyed between the kitchen facility and the dining areas so as to improve the efficiency of the system in servicing the restaurant patrons, wherein the loading and unloading of patron food orders and dirty dishes is heavily automated so as to improve the efficiency of the system still further, wherein patron food orders are maintained separate from bus tubs containing dirty dishes so as to maximize sanitary conditions within the restaurant facility, and wherein the conveyors for conveying the patron food orders can be operated in a reverse direction so as to return patron food orders back to the kitchen facility in the instance that, for example, a particular food order was incorrect or incorrectly prepared.

### OVERALL OBJECTIVES OF THE INVENTION

Therefore, a first overall objective of the present invention is to provide a new and improved multi-level conveyor system. Another need exists in the art for a new and improved multi-level conveyor system which can be utilized within restaurant facilities. Still another overall objective of the present invention is to provide a new and improved multi-level conveyor system which can be utilized within restaurant establishments wherein, for example, the kitchen is located upon one floor or level and the dining areas are located upon a different floor or level. Yet another overall objective of the present invention is to provide a new and improved multi-level conveyor system which can be utilized within restaurant establishments wherein, for example, the kitchen facility is located upon one floor or level and the dining areas are located upon a different floor or level, and wherein patron food orders and bus tubs containing dirty dishes can be simultaneously conveyed between the kitchen facility and the dining areas. Still yet another overall objective of the present invention is to provide a new and improved multi-level conveyor system which can be utilized within restaurant establishments wherein, for example, the kitchen facility is located upon one floor or level and the dining areas are located upon a different floor or level, and wherein patron food orders and bus tubs containing dirty dishes can be simultaneously conveyed between the kitchen facility and the dining areas so as to improve the efficiency of the system in servicing the restaurant patrons. Yet still another overall objective of the present invention is to provide a new and improved multi-level conveyor system which can be utilized within restaurant establishments wherein, for example, the kitchen facility is located upon one floor or level and the dining areas are located upon a different floor or level, wherein patron food orders and bus tubs containing dirty dishes can be simultaneously conveyed between the kitchen facility and the dining areas so as to improve the efficiency of the system in servicing the restaurant patrons, and wherein the loading and unloading of patron food orders and dirty dishes is heavily automated so as to improve the efficiency of the system still further.

A further overall objective of the present invention is to provide a new and improved multi-level conveyor system which can be utilized within restaurant establishments wherein, for example, the kitchen facility is located upon one floor or level and the dining areas are located upon a different floor or level, wherein patron food orders and bus tubs containing dirty dishes can be simultaneously conveyed between the kitchen facility and the dining areas so as to improve the efficiency of the system in servicing the restaurant patrons, wherein the loading and unloading of patron food orders and dirty dishes is heavily automated so as to improve the efficiency of the system still further, and wherein patron food orders are maintained separate from bus tubs containing dirty dishes so as to maximize sanitary conditions within the restaurant facility. A still further overall objective of the present invention is to provide a new and improved multi-level conveyor system which can be utilized within restaurant establishments wherein, for example, the kitchen facility is located upon one floor or level and the dining areas are located upon a different floor or level, wherein patron food orders and bus tubs containing dirty dishes can be simultaneously conveyed between the kitchen facility and the dining areas so as to improve the efficiency of the system in servicing the restaurant patrons, wherein the loading and unloading of patron food orders and dirty dishes is heavily automated so as to improve the efficiency of the system still further, wherein patron food orders are maintained separate from bus tubs containing dirty dishes so as to maximize sanitary conditions within the restaurant facility, and wherein the conveyors for conveying the patron food orders can be operated in a reverse direction so as to return patron food orders back to the kitchen facility in the instance that, for example, a particular food order was incorrect or incorrectly prepared.

### SUMMARY OF THE INVENTION

The foregoing and other objectives are achieved in accordance with the principles and teachings of the present invention through the provision of a new and improved multi-level conveyor system which comprises a vertical tower extending vertically upwardly from a lower floor or level to an upper floor or level. The lower floor or level can be the kitchen facility while the upper floor or level can be the dining areas, although, of course, this particular restaurant arrangement can be reversed. A first, lower level, loading and/or unloading station is operatively connected to the lower end of the vertical tower, while a second, upper level, loading and/or unloading station is operatively connected to the upper end of the vertical tower. Each one of the loading and/or unloading stations comprises upper and lower tiers of conveyors, while a movable carriage, also comprising upper and lower tiers of conveyors, is disposed within the vertical tower. Accordingly, in accordance with the principles and teachings of this invention, freshly prepared patron food orders can be loaded into the first, lower level, loading/unloading station for transportation to the vertical tower and to the second, upper level, loading and/or unloading station whereby the freshly prepared patron food orders can then be distributed to particular restaurant patrons, while simultaneously, bus tubs, containing dirty dishes and utensils from the dining areas, can be unloaded from the first, lower level, loading and/or unloading station. In a similar manner, freshly prepared patron food orders can be unloaded from the second, upper level, loading/unloading station whereby the same can then be distributed to particular restaurant patrons, while simultaneously, bus tubs, containing dirty dishes and utensils from the dining areas, can be loaded onto the second, upper level, loading and/or unloading station whereby the same will then be conveyed onto the vertically movable carriage, disposed within the vertical tower, such that the bus tubs, containing the dirty dishes and utensils from the dining areas, can then be transported back to the first, lower level, loading/unloading station located within the kitchen facility whereby the bus tubs, dirty dishes, and dirty utensils can be cleaned by suitable kitchen appliances.

### BRIEF DESCRIPTIONS OF THE DRAWINGS

Various other objects, features and attendant advantages of the present invention will be more fully appreciated from the following detailed description when considered in connection with the accompanying drawings in which like reference characters designate like or corresponding parts throughout the several views, and wherein:

FIG. 1 is a perspective view of the new and improved multi-level conveyor system, with dual loading/unloading stations, as developed in accordance with the principles and teachings of the present invention;

FIG. 2 is a side elevational view of the vertical tower and the first, lower level, loading/unloading station showing the multiple, dual-tiered conveyors disposed within serially arranged loading and unloading zones defined within the first, lower level, loading/unloading station;

FIG. 3 is a front elevational view of one of the loading and/or unloading stations showing one of the dual-tiered conveyors for conveying patron food orders upon the upper conveyor tier and bus tubs containing dirty dishes and utensils upon the lower conveyor tier;

FIG. 4 is a side elevational view of the vertical tower and the first, lower level, loading/unloading station, similar to that of FIG. 2, showing, schematically, the directional movements of the patron food orders disposed upon the upper tier of conveyors incorporated within the first, lower level, loading/unloading station, and within the vertical tower, as well as the directional movements of the bus tubs, containing dirty dishes and utensils, disposed upon the lower tier of conveyors incorporated within the vertical tower and within the first, lower level, loading/unloading station;

FIG. 5 is a side elevational view of the vertical tower and the second, upper level, loading/unloading station showing the multiple, dual-tiered conveyors disposed within serially arranged loading and unloading zones defined within the second, upper level, loading/unloading station;

FIG. 6 is a side elevational view of the vertical tower and the first, lower level, loading/unloading station, similar to that of FIG. 5, showing, schematically, the directional movements of the patron food orders disposed upon the upper tier of conveyors incorporated within the vertical tower and within the second, upper level, loading/unloading station, as well as the directional movements of the bus tubs, containing dirty dishes and utensils, disposed upon the lower tier of conveyors incorporated within the second, upper level, loading/unloading station, and within the vertical tower;

FIG. 7 is a side elevational view of the lower end portion of the vertical tower, and the left end portion of the first, lower level, loading and/or unloading station, illustrating the fact that the loading/unloading stations are mounted upon casters and are detachably connected to the vertical tower so as to facilitate cleaning of the loading/unloading stations; and

FIG. 8 is a perspective view of the first, lower level, loading and/or unloading station, illustrating the fact that the various conveyors are detachable from the loading/unloading stations so as to facilitate cleaning or servicing of the same.

### DETAILED DESCRIPTION OF THE PREFERRED EMBODIMENT

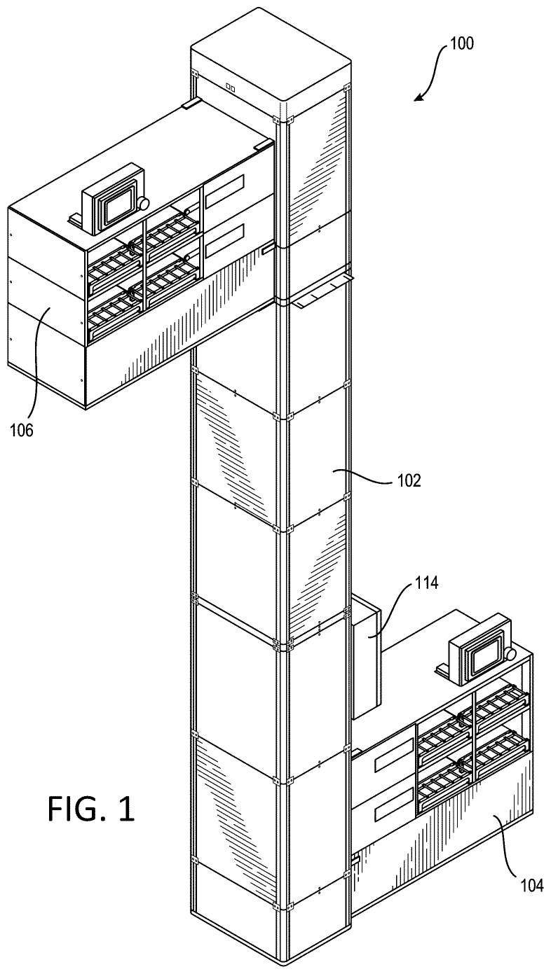

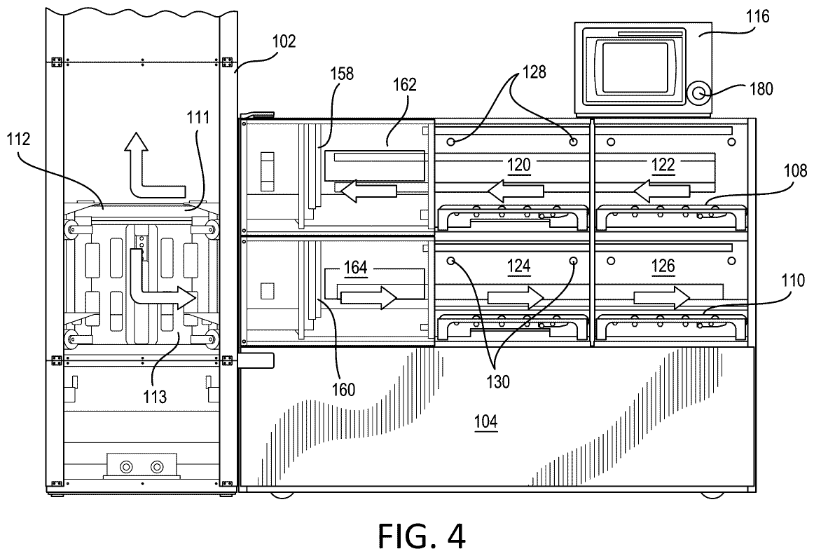

Referring now to the drawings, and more particularly to FIGS. 1-6 thereof, a new and improved multi-level conveyor system, as constructed in accordance with the principles and teachings of the present invention, is disclosed and is generally indicated by the reference character 100. More particularly, it is seen that the new and improved multi-level conveyor system 100 comprises a vertical tower 102 which extends vertically upwardly from a lower floor or level to an upper floor or level. The lower floor or level can be the kitchen facility while the upper floor or level can be the dining areas, although, of course, this particular restaurant arrangement can be reversed. A first, lower level, loading and/or unloading station 104 is operatively connected to the lower end of the vertical tower 102, while a second, upper level, loading and/or unloading station 106 is operatively connected to the upper end of the vertical tower 102. Each one of the loading and/or unloading stations 104,106 comprises upper and lower tiers of conveyors 108,110, while a movable carriage 112, as can best be schematically seen in FIG. 4, and also comprising upper and lower tiers of conveyors 111,113, is disposed within the vertical tower 102. Accordingly, in accordance with the principles and teachings of this invention, freshly prepared patron food orders can be loaded into the first, lower level, loading/unloading station 104 for transportation to the vertical tower 102 and to the second, upper level, loading and/or unloading station 106 whereby the freshly prepared patron food orders can then be distributed to particular restaurant patrons, while simultaneously, bus tubs, containing dirty dishes and utensils from the dining areas, can be unloaded from the first, lower level, loading and/or unloading station 104.

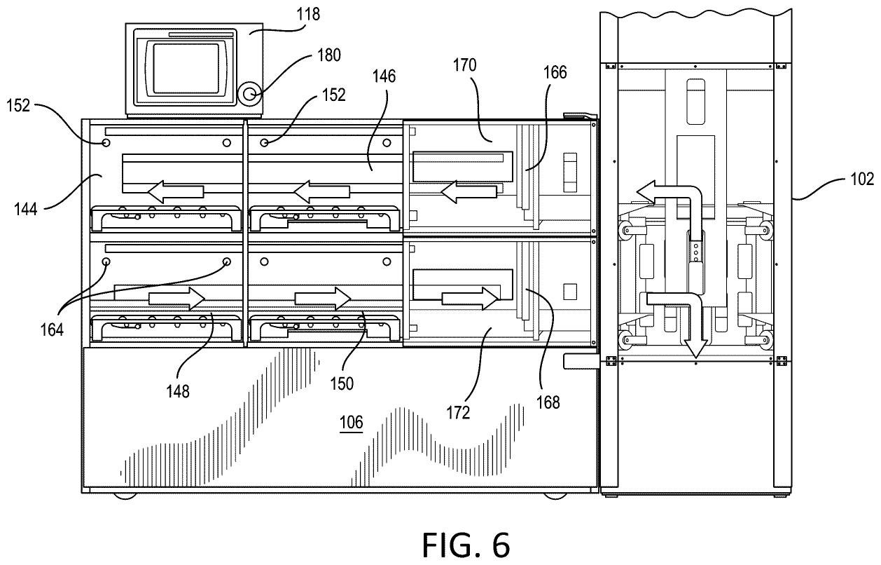

In a similar manner, freshly prepared patron food orders can be unloaded from the second, upper level, loading/unloading station 106 whereby the same can then be distributed to particular restaurant patrons, while simultaneously, bus tubs, containing dirty dishes and utensils from the dining areas, can be loaded onto the second, upper level, loading and/or unloading station 106 whereby the same will then be conveyed onto the vertically movable carriage 112, disposed within the vertical tower 102, such that the bus tubs, containing the dirty dishes and utensils from the dining areas, can then be transported back to the first, lower level, loading/unloading station 104 located within the kitchen facility whereby the bus tubs, dirty dishes, and dirty utensils can be cleaned by suitable kitchen appliances. As shown within FIGS. 4 and 6, these conveyor movements are schematically illustrated by means of flow directional movement arrows, although it is to be noted that such flow directional movements may be reversed. For example, while patron food orders are normally conveyed upon conveyors 108 moving from right to left within the first, lower level, loading/unloading station 104 for transportation to the vertical tower 102, conveyors 108 could be programmed to move from left to right when, for example, an incorrect patron food order is being returned from the dining area to the kitchen facility, such as, for example, in the instance that the patron food order was not prepared correctly or was in fact an incorrect order. Similarly, while bus tubs are normally conveyed upon conveyors 110 moving from left to right within the first, lower level, loading/unloading station 104, as received from the vertical tower 102, when such bus tubs are delivering dirty dishes, glasses, and utensils from the dining areas to the kitchen facility, conveyors 110 could be programmed to move from right to left when, for example, clean bus tubs are being conveyed from the kitchen facility to the dining areas. It is noted, and hereby emphasized, that a critically important feature of the conveyor system 100 is that patron food orders and bus tubs are always maintained separate from each other. Therefore, regardless of whether patron food orders are being conveyed from the kitchen facility to the dining areas for distribution to patrons, or being returned from the dining areas to the kitchen facility for some correction of the patron food order, and regardless of whether bus tubs, containing dirty dishes, glasses, and utensils, are being conveyed from the dining areas to the kitchen facility so as to be cleaned, or whether clean bus tubs are being conveyed from the kitchen facility to the dining areas, the patron food orders are always conveyed upon the upper level conveyors 108 while the bus tubs are always conveyed upon the lower level conveyors 110. This mode of operation ensures cleanliness and compliance with restaurant sanitary requirements and regulations.

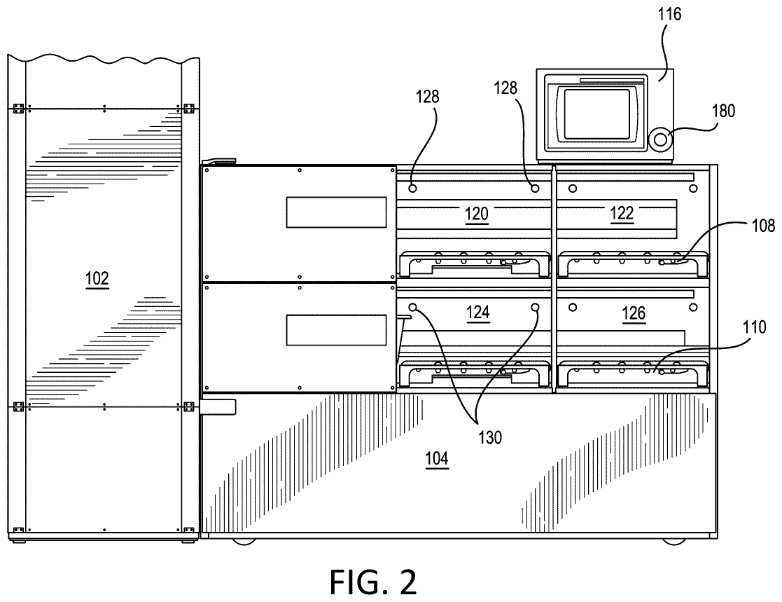

Continuing further, it is seen that the entire multi-level conveyor system 100 is controlled by means of a suitable computer-controlled system 114 which may be a central processing unit (CPU) or a programmable logic controller (PLC). In addition, it is seen that each one of the loading and/or unloading stations 104,106 is provided with an HMI (Human Machine Interface) 116,118 whereby restaurant personnel can interact with the multi-level conveyor system 100 so as to control the various operations thereof. Still yet further, and as can best be seen from FIGS. 2 and 4, it is seen that the upper and lower tiers of conveyors 108,110 of the first, lower-level loading and/or unloading station 104 are disposed in serially arranged loading and/or unloading zones or regions 120,122,124,126. A plurality of sensors 128,130 are operatively installed within each one of the loading and/or unloading zones or regions or staging areas 120, 122,124, 126, and the sensors 128,130 are electronically connected to the HMI (Human Machine Interface) 116. The sensors 128 detect the presence of a patron food order tray loaded into each one of the patron food order zones or regions or staging areas 120,122, while the sensors 130 detect the presence of a bus tub loaded into each one of the bus tub zones or regions or staging areas 120,122. Signals from the plurality of sensors 128, 130 are transmitted back to the HMI (Human Machine Interface) 116 whereby restaurant personnel can monitor the state of the plurality of loading and/or unloading zones or regions or staging areas 120, 122, 124, 126 so that, for example, it will be known whether or not a particular zone or region or staging area 120,122,124,126 is occupied or empty.

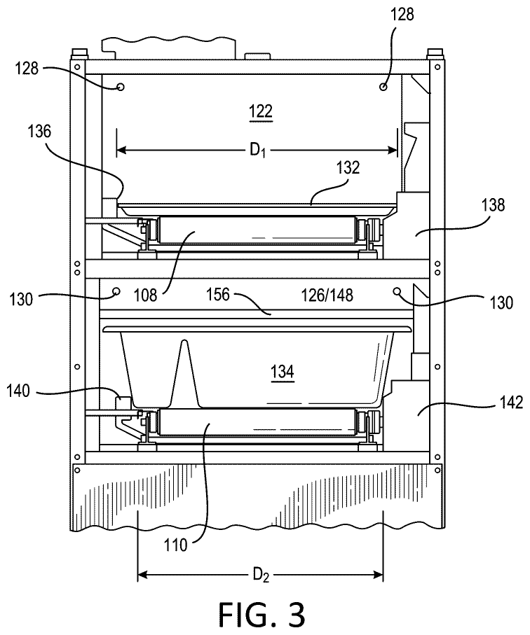

In addition, the sensors 128,130 also detect whether or not the patron food order tray or the bus tub is properly located or oriented upon the conveyors 108,110 such that when the conveyors 108,110 convey patron food order trays or clean bus tubs onto the vertically movable carriage 112 disposed within the vertical tower 102, the patron food order trays or clean bus tubs will be able to be properly loaded onto the vertically movable carriage 112 disposed within the vertical tower 102, and will not interfere with vertical movement of the vertically movable carriage 112 within the vertical tower 102. Still further, the sensors 128,130 can also detect whether the object loaded onto the upper tier conveyors 108 is a patron food order tray 132 or a bus tub 134. If the latter, this error will be transmitted to the HMI (Human Machine Interface) 116 whereby restaurant personnel will then rectify the situation. Similarly with respect to a patron food order tray being improperly loaded onto the lower tier conveyors 110. As can also be appreciated from FIG. 3, in order to further ensure that only patron food order trays 132 can be loaded onto the upper tier conveyors 108 disposed within the upper loading zones or regions or staging areas 120,122, and that only bus tubs 134 can be loaded onto the lower tier conveyors 110 disposed within the lower unloading zones or regions or staging areas 124,126, it is seen that the upper and lower conveyor tiers have different structural geometry.

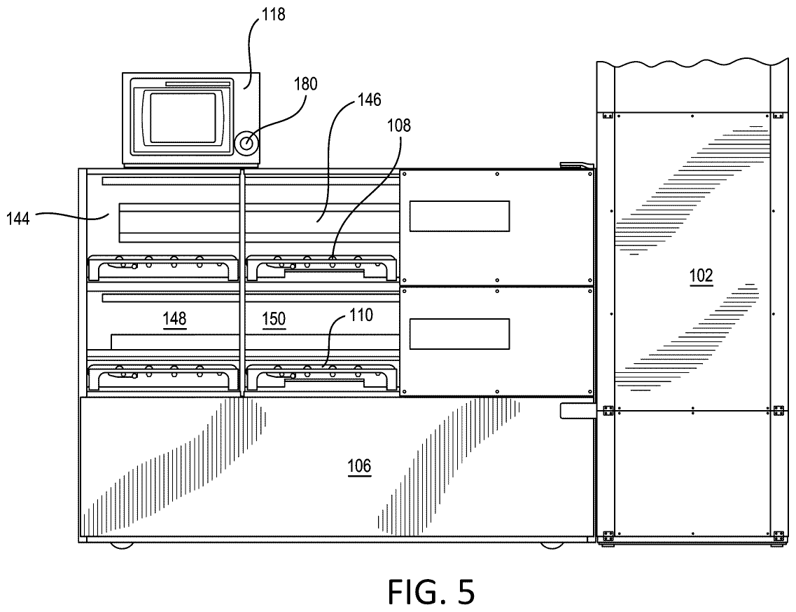

For example, as can be seen in FIG. 3, the upper tier conveyor assembly 108 comprises a first conveyor guide rail 136 which is operatively associated therewith so as to effectively engage or be disposed immediately adjacent to left-hand edge portions of the patron food order trays 132, while a first guide block 138 is disposed immediately adjacent to right-hand edge portions of the patron food order tray 132, and that the first conveyor guide rail 136 and the first guide block 138 are spaced from each other through means of a first predetermined distance D₁ so as to in fact accommodate the patron food order trays 132. To the contrary, the lower tier conveyor assembly 110 comprises a second conveyor guide rail 140 which is operatively associated therewith so as to effectively engage or be disposed immediately adjacent to left-hand edge portions of the bus tubs 134, while a second guide block 142 is disposed immediately adjacent to right-hand edge portions of the bus tubs, and that the second conveyor guide rail 140 and the second guide block 140 are spaced from each other through means of a second predetermined distance D₂ so as to in fact accommodate the bus tubs 134, wherein it is clear that the second predetermined distance D₂ is less than the first predetermined distance D₁. Of course, it is to be further appreciated that, as can best be seen from FIGS. 5 and 6, which are similar to FIGS. 2 and 4, it is seen that the upper and lower tiers of conveyors 108,110 of the second, upper-level loading and/or unloading station 106 are likewise disposed in serially arranged loading and/or unloading zones or regions or staging areas 144,146,148,150, and a plurality of sensors 152,154, similar to sensors 128,130, are operatively installed within each one of the loading and/or unloading zones or regions or staging areas 144,146,148,150.

Still yet further, and with reference being made to both FIGS. 3 and 6, a horizontally oriented bar or mechanical stop 156 is disposed within at least the first bus tub loading region or zone or staging area 148 so as to extend across the entire width of the first bus tub loading region of zone or staging area 148. The purpose of the bar 156 is to effectively intercept or engage objects within a particular bus tub 134 when the bus tub 134 is overloaded, which might present a weight problem for the conveyors 110. If objects in the bus tub 134 do engage the horizontal bar 156, a signal will be transmitted to halt operation of the conveyor 110 whereby restaurant personnel will need to rectify the problem. It is also noted that all of the conveyors 108,110 disposed within a particular tier of conveyors are driven by means of a single motor drive and yet are individually controlled as a result of being capable of being operatively connected to, or disconnected from, the single motor drive by means of suitable electromagnetic clutch mechanisms, not shown. It is lastly noted that with respect to the various tiers of conveyors 108,110 disposed within the first, lower level, loading and/or unloading station 104 and within the second, upper level, loading and/or unloading station 106, light curtains 158, 160 are respectively provided within final pre-vertical zones or regions or staging areas 162,164 located between the loading and unloading regions or zones 120,124 of the first, lower-level loading and unloading station 104 and the vertical tower 102, while similar light curtains 166,168 are respectively provided within post-vertical zones or regions or staging areas 170,172 located between the unloading and loading regions or zones 146,150 of the second, upper-level loading and unloading station 106 and the vertical tower 102. The purpose of the light curtains 158, 160, 166, 168 is to immediately shut down or terminate movement of the vertically movable carriage 112, disposed within the vertical tower 102, should human movement within the aforenoted zones or regions or staging areas 162,164, 170,172 be detected. Such immediate shutdown or termination of any movement of the vertically movable carriage 112, disposed within the vertical tower 102, is a safety feature to prevent any injury to human personnel.

Having described substantially all of the operative components of the new and improved multi-level conveyor system 100, as constructed in accordance with the principles and teachings of the present invention, a brief description of the operation of the same will now be provided. When, for example, a tray 132, loaded with a particular patron food order, is placed into the first loading zone or region 122, the sensors 128 will immediately detect the presence of the patron order food tray 132 and will initiate operation of the system whereby the system will then check or determine if the subsequent zone or region or staging area 120 is in fact free. If it is, the conveyors 108 will advance the patron food order tray 132 to the next zone or region or staging area 120, and this process continues until the patron food order tray 132 is conveyed into the pre-vertical zone or region or pre-vertical staging area 162. Of course, if a particular subsequent zone or region or staging area is not in fact free, then conveyance of the patron order food tray 132 will be halted until the time that the subsequent zone or region or staging area does in fact become free. Continuing further, when in fact the particular patron food order tray 132 is disposed within the pre-vertical zone or region or staging area 162, the computer-controlled system 114 will then activate the vertically movable carriage 112, disposed within the vertical tower 102, so as to move the vertically movable carriage 112 downwardly, if the upper conveyor 111 of the vertically movable carriage 112 is free, such that the upper conveyor 111 of the vertically movable carriage 112 will effectively be vertically aligned with the conveyors disposed within pre-vertical zone or region or staging area 162 whereby the patron food order tray 132 can in fact be conveyed from the conveyors disposed within the pre-vertical zone or region or staging area 162 onto the upper conveyor 111 of the vertically movable carriage 112.

If the upper conveyor 111 of the vertically movable carriage 112 is not free, then that means that it contains a patron food order which must be delivered to the dining areas before the vertically movable carriage 112 can be moved downwardly so as to be capable of accepting the new patron food order tray 132. When the patron food order tray 132 is then conveyed onto the upper conveyor 111 of the vertically movable carriage 112, the vertically movable carriage 112 will then be moved upwardly until the upper conveyor 111 of the vertically movable carriage 112 is aligned with the conveyors disposed within the upper post-vertical zone or region or staging area 170. If in fact the upper post-vertical zone or region or staging area 170 is free, then movement of the upper conveyor 111 of the vertically movable carriage 112 is activated. If the upper post-vertical zone or region or staging area 170 is not free or unoccupied, then movement of the upper conveyor 111 of the vertically movable carriage 112 is halted until the upper post-vertical zone or region or staging area 170 becomes free. The patron food order tray 132 will then move through the successive unloading zones or regions or staging areas 146,144 until the particular patron food order tray 132 is ready to be unloaded from the unloading zone or region or staging area 144 for delivery to the particular patron who placed the particular food order. The mode of operation in connection with the return of the bus tubs 134 from the dining areas to the kitchen facility is basically the same as that comprising the delivery of the patron food order trays 132, except in reverse.

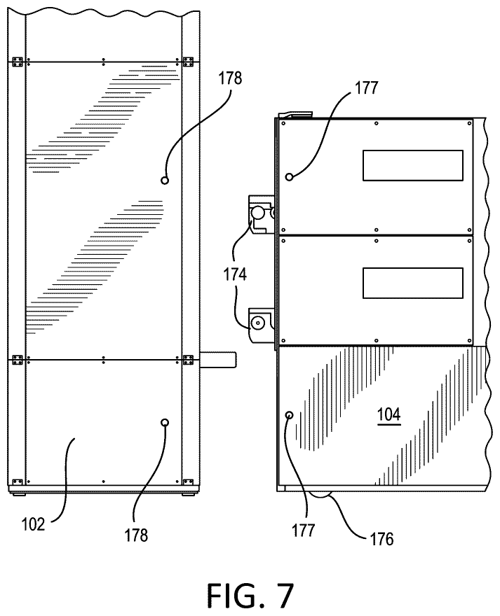

With reference now being made to FIG. 7, it is noted that each one of the first, lower level, and second, upper level, loading and/or unloading stations 104,106 is detachable from the vertical tower 102 so as to facilitate cleaning or other services that need to be performed upon the first, lower level, and second, upper level loading and/or unloading stations 104, 106. More particularly, it is seen that the first, lower level, and second, upper level, loading and/or unloading stations 104,106 are detachable from the vertical tower 102 by means of suitable male connectors and locking structures 174, mounted upon the end wall portions of the first, lower level, and second, upper level, loading and/or unloading stations 104,106, while suitable female connectors and corresponding locking structures, not shown, are mounted within end wall portions of the vertical tower 102. In addition, the first, lower level, and second, upper level, loading and/or unloading stations 104, 106 are mounted upon casters 176 so as to facilitate movement of the first, lower level, and second, upper level, loading and/or unloading stations 104, 106 from their locations, where they are operationally connected to the vertical tower 102, to suitable cleaning facilities or stations, not shown. Lastly, it is noted that sensors 177,178 can be incorporated within the first, lower level, and second, upper level, loading and/or unloading stations 104,106, and the vertical tower 102 so as to likewise shutdown movement or drive of the vertically movable carriage 112, disposed within the vertical tower 102, when in fact either one of the first, lower level, or second, upper level, loading and/or unloading stations 104,106, is detached from the vertical tower 102. In a similar manner, and as an additional safety measure incorporated into the system, an estop or emergency stop button 180 is effectively incorporated into the system by providing the same upon each HMI (Human Machine Interface) 116 so that restaurant personnel can immediately shut down the system should circumstances warrant the same. To restore power or drive to the system, the estop or emergency stop buttons 180 can be released, or depressed a second time, or alternatively, separate power buttons, not shown, can likewise be incorporated into or provided upon each HMI (Human Machine Interface) 116.

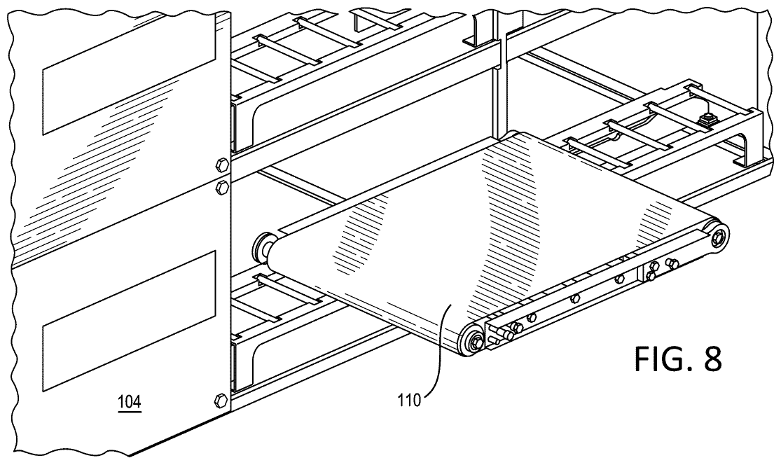

Still yet further, with reference lastly being made to FIG. 8, it is seen that all of the conveyors 108, 110 are readily detachable from the first, lower level, and second, upper level, loading and/or unloading stations 104,106 so as to be capable of being easily transported to suitable cleaning facilities or stations, not shown. Magnetic couplings, not shown, permit the conveyors 108,110 to be readily detached or disconnected from the first, lower level, and second, upper level, loading and/or unloading stations 104,106, and to then be re-attached or re-connected to the first, lower level, and second, upper level, loading and/or unloading stations 104,106 upon conclusion of the cleaning operations.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent, is:

1. A smart conveyor system for an establishment, comprising:
a vertically oriented conveyor tower, having a vertically moving conveyor disposed therein, having a lower end portion operatively associated with a first floor of the establishment, and an upper end portion operatively associated with a second floor of the establishment, such that said vertically oriented conveyor tower extends between said first floor of the establishment and said second floor of the establishment;
a first horizontally oriented loading/unloading station having first conveyors operatively associated with said lower end portion of said vertically oriented conveyor tower for delivering first objects from said first floor of the establishment to said lower end portion of said vertically oriented conveyor tower for delivery of the first objects to said second floor of the establishment by said vertically moving conveyor disposed within said vertically oriented conveyor tower, and for receiving second objects from said lower end portion of said vertically oriented conveyor tower; and
a second horizontally oriented loading/unloading station having second conveyors operatively associated with said upper end portion of said vertically oriented conveyor tower for delivering the first objects from said upper end portion of said vertically oriented conveyor tower for delivery to said second floor of the establishment, and for receiving second objects from said second floor of said restaurant for delivery to said upper end portion of said vertically oriented conveyor tower such that said vertically moving conveyor of said vertically oriented conveyor tower can convey the second objects back to said first floor of the establishment.

2. The smart conveyor system as set forth in claim 1, wherein:
said vertically movable carriage, and said first and second horizontally oriented loading/unloading stations, all comprise upper and lower conveyor tiers for respectively conveying the first and second objects in a separated manner.

3. The buffered smart conveyor system as set forth in claim 2, wherein:
said establishment is a restaurant and said upper tiers of said vertically moving conveyor, and said upper tiers of said first and second horizontally oriented loading/unloading stations, all convey food orders from said first floor of said restaurant to said second floor of said restaurant.

4. The smart conveyor system as set forth in claim 2, wherein:
said establishment is a restaurant and said lower tiers of said vertically moving conveyor, and said lower tiers of said first and second horizontally oriented loading/unloading stations, all convey bus tubs from said second floor of said restaurant to said first floor of said restaurant.

5. The smart conveyor system as set forth in claim 1, wherein:
the establishment is a restaurant wherein said first floor of said restaurant comprises a kitchen facility where said food orders are prepared, and said second floor of said restaurant comprises a dining area where food patrons can eat their food orders.

6. The smart conveyor system as set forth in claim 5, further comprising:
sensors, disposed within said first and second horizontally oriented loading/unloading stations, for initiating activation of said conveyors, disposed within said first and second horizontally oriented loading/unloading stations, when patron food order trays are detected within said first horizontally oriented loading/unloading station, and when bus tubs are detected within said second horizontally oriented loading/unloading station.

7. The smart conveyor system as set forth in claim 6, wherein:
all of said conveyors, disposed within said first and second horizontally oriented loading/unloading stations, are independently operable.

8. The smart conveyor system as set forth in claim 6, further comprising:
a computer-control system for independently controlling all of said conveyors disposed within said first and second horizontally oriented loading/unloading stations.

9. The smart conveyor system as set forth in claim 8, wherein:
said computer-control system comprises a computer selected from the group comprising a central processing unit (CPU) and a programmable logic controller (PLC).

10. The smart conveyor system as set forth in claim 9, wherein:
all of said conveyors, disposed within said first and second horizontally oriented loading/unloading stations, are arranged within a plurality of zones/regions/staging areas wherein said patron food order trays are moved from a first zone/region/staging area to a second zone/region/staging area depending upon said second zone/region/staging area is free or unoccupied.

11. The smart conveyor system as set forth in claim 2, wherein:
the establishment is a restaurant wherein said first floor of said restaurant comprises a kitchen facility where said food orders are prepared, and said second floor of said restaurant comprises a dining area where food patrons can eat their food orders; and
structural components are disposed within said first and second horizontally oriented loading/unloading stations for preventing bus tubs from being loaded onto said upper tiers of conveyors disposed within said first and second horizontally oriented loading/unloading stations, and for preventing patron food order trays from being loaded onto said lower tiers of conveyors disposed within said first and second horizontally oriented loading/unloading stations.

12. The smart conveyor system as set forth in claim 4, wherein:
a mechanical stop is operatively disposed in conjunction with said lower tier of conveyors, disposed within said second horizontally oriented loading/unloading station, for preventing overloading of said bus tubs when said bus tubs are loaded onto said lower tier of conveyors disposed within said second horizontally oriented loading/unloading station.

13. The smart conveyor system as set forth in claim 2, wherein:
said upper and lower conveyor tiers, disposed within said first and second horizontally oriented loading/unloading stations, permit said first and second objects to be simultaneously loaded and unloaded at said first and second horizontally oriented loading/unloading stations.

14. The smart conveyor system as set forth in claim 7, wherein:
all of said conveyors, disposed within said first and second horizontally oriented loading/unloading stations, are able to be operated in reverse modes.

15. The smart conveyor system as set forth in claim 1, further comprising:
light curtains operatively associated with said first and second horizontally oriented loading/unloading stations for terminating vertical movement of said vertically movable conveyor, disposed within said vertically oriented conveyor tower, should human presence within one of said first and second horizontally oriented loading/unloading stations be detected.

16. The smart conveyor system as set forth in claim 1, wherein:
said first and second horizontally oriented loading/unloading stations are detachable from said vertically oriented conveyor tower for facilitating cleaning of said first and second horizontally oriented loading and/or/unloading stations.

17. The smart conveyor system as set forth in claim 16, wherein:
said first and second horizontally oriented loading/unloading stations, detachable from said vertically oriented conveyor tower, are provided with mechanical connectors and locking structures for permitting said first and second horizontally oriented loading/unloading stations to be detached from said vertically oriented conveyor tower and to be re-attached to said vertically oriented conveyor tower.

18. The smart conveyor system as set forth in claim 1, wherein:
said first conveyors, disposed within said first horizontally oriented loading/unloading station, and said second conveyors, disposed within said second horizontally oriented loading/unloading station, are detachable from said first and second horizontally oriented loading/unloading stations.
